(19) United States
(12) Patent Application Publication
(10) Pub. No.: US 2006/0082941 A1
(43) Pub. Date: Apr. 20, 2006

(54) Installation appliance and installation system comprising one such installation appliance

(76) Inventors: Wolfgang Brandl, Amberg (DE); Klaus Busch, Amberg (DE)

Correspondence Address: HARNESS, DICKEY & PIERCE, P.L.C., P.O.BOX 8910, RESTON, VA, 20195, US

(21) Appl. No.: 10/545,372

(22) PCT Filed: Jan. 29, 2004
(86) PCT No.: PCT/EP04/00811

§ 371 Date: Aug. 12, 2005

(30) Foreign Application Priority Data
Feb. 14, 2003 (EP) 03003446.6

(51) Int. Cl. H02H 3/08

(52) U.S. Cl. 361/93.1

(57) ABSTRACT

An installation appliance and an installation system including at least one installation appliance are proposed, which respectively ensure rational wiring with simple device(s) for connectable devices including a given number of current paths. To this end, the installation appliance can be brought into contact—by different-sided connection channels—with a device, another device, or a third device including a respectively predeterminable number of current paths. The current conduction of at least one of the current paths can be influenced by way of an appliance unit.

This application is the national phase under 35 U.S.C. § 371 of PCT International Application No. PCT/EP2004/000811 which has an International filing date of Jan. 29, 2004, which designated the United States of America and which claims priority on European Patent Application number EP 03003446.6 filed Feb. 14, 2003, the entire contents of which are hereby incorporated herein by reference.

### FIELD

The invention generally relates to an installation appliance and/or an installation system including at least one installation appliance.

### BACKGROUND

WO 99/23737 discloses a modularly constructed load branch composed of a branch assembly and a base lower part with integrated line and/or bus sections. In this case, the base lower part can be extended to form a modular carrier system with a line and bus system by adding on and making contact with further structurally identical base lower parts for receiving further branch assemblies or input or output assemblies.

### SUMMARY

An object of at least one embodiment of the present invention is to specify an installation appliance and/or an installation system comprising at least one installation appliance. As such, efficient wiring via simple devices for connectable devices having a given number of current paths may be achieved.

In at least one embodiment, on the basis of the installation appliance having a predeterminable number of connection channels, which can be contact-connected to corresponding current paths of different devices both at a first appliance location and at a second appliance location and are in each case provided for a current flow, what may be achieved with at least one appliance unit of at least one embodiment is that the current flow can be influenced, depending on the application, in the sense of a planned leading out and/or forwarding of the respective connection channel of the appliance unit. In this case, possibly unassigned current paths of the connectable devices can be used and an efficient—taking account of the number of current paths—wiring of the respective channels is thereby ensured with simple device(s).

With regard to the installation system in at least one embodiment including at least one installation appliance which has a predeterminable number of connection channels, which are contact-connected to different devices both at a first appliance location and at a second appliance location and for their part have a predeterminable number of current paths for a current flow, it is provided that an appliance unit can be used to influence the current flow fed in through the current paths of the devices in at least one of the connection channels of the appliance unit. In this case, the connection channels of the appliance unit that can be modified in terms of their current carrying afford a device-side, possibly complete utilization of the current paths, thereby ensuring an efficient, that is to say system-conforming, wiring with simple device(s).

The appliance unit is advantageously embodied as an interface in such a way that at least one of the connection channels can be led through, or can be interrupted, by way of an electrically conductive bridge. Depending on the application, a demand-oriented assignment of the current paths is afforded by the interface, so that on the one hand a variable wiring and on the other hand a high utilization are obtained.

### BRIEF DESCRIPTION OF THE DRAWINGS

The invention and also advantageous refinements in accordance with features of the further claims are explained in more detail below on the basis of example embodiments illustrated in the drawing, in which:

FIG. 1 shows a schematically illustrated installation system with an installation appliance;

FIGS. 2 and 3 show different embodiments—having an installation appliance—of the installation system with at least one supply component and distribution component;

FIGS. 4.1 to 4.6 show sections of an installation appliance with different implementations;

FIGS. 5 and 6 show different embodiments of the installation system with implementations of a distribution component;

FIGS. 7 to 10 show different embodiments—having at least one installation appliance—of an installation system with supply and distribution components;

FIGS. 11 and 12 show different embodiments of an installation system with an evaluation component;

FIGS. 13 and 14 show different embodiments of the installation system with an evaluation component and a distribution component.

### DETAILED DESCRIPTION OF THE EXAMPLE EMBODIMENTS

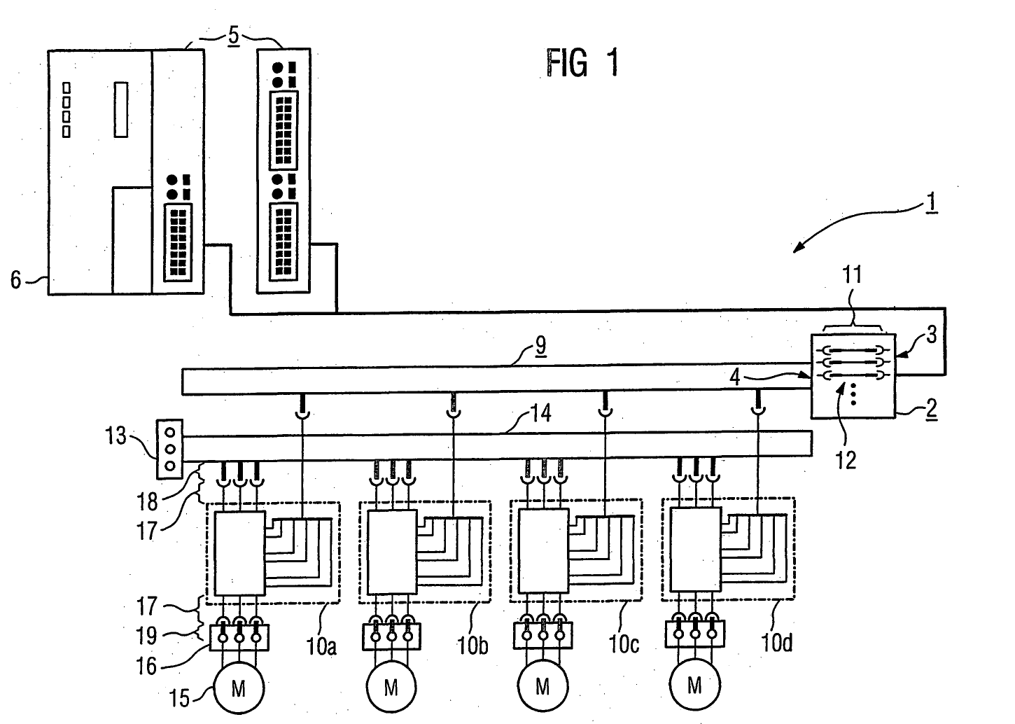

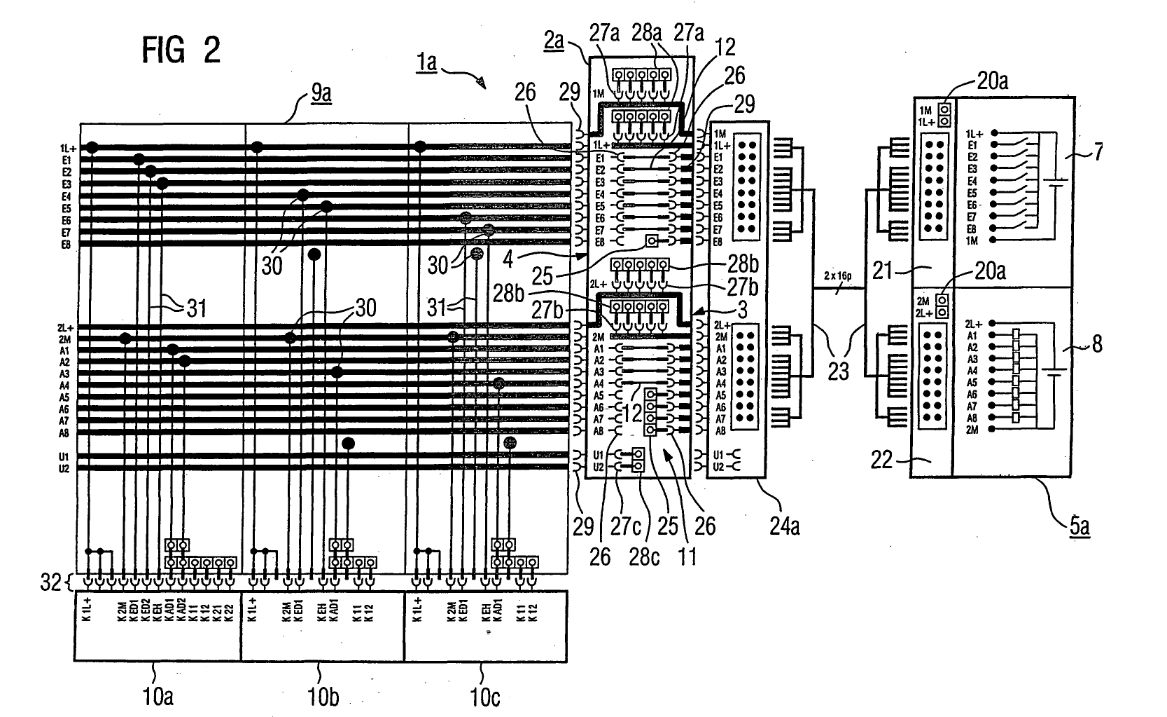

FIG. 1 shows a schematically illustrated installation system 1 having an installation appliance, in particular a logic component 2. The logic component 2 has a predeterminable number of current paths, in particular connection channels, for example in accordance with the example of FIG. 2. The connection channels—also called bridging channels—can be contact-connected both at a first appliance location 3 and at a second appliance location 4 in the sense of an intermediate arrangement of the logic component 2 and are in each case provided for a current flow.

In accordance with the present example embodiment, two devices, in particular supply components 5, having a respectively predeterminable number of current paths, in particular supply channels, e.g. in accordance with FIG. 2, corresponding to the number of connection channels are connected to the connection channels of the first appliance location 3. The respective supply component 5 is part of a controller 6, in particular stored-program controller (SPC), which is provided with a central processing unit (CPU) for signal processing.

The supply components 5 have on the one hand sixteen input channels embodied as supply channels, and on the other hand eight output channels likewise embodied as supply channels. Accordingly, the respective supply channels afford a supply of the controller 6 with input signals, on the one hand, and a supply of at least one further device, in particular distribution component 9, with output signals, on the other hand. The distribution component 9 is connected to the connection channels of the logic component 2 at the second appliance location 4 in the sense of a wiring component having a predeterminable number of current paths, in particular distribution channels, e.g. in accordance with FIG. 2. Via the distribution channels of the distribution component 9, besides a first electrical functional component 10a a second, third and fourth electrical functional component 10b to 10d are fed with a supply voltage, in particular auxiliary voltage, of an auxiliary circuit.

The current flow in at least one of the connection channels can be influenced by an appliance unit 11 of the logic component 2 that is embodied as a configurable interface. The respective connection channel can be led through, or interrupted, by way of an electrically conductive bridge 12, so that unassigned supply channels of the supply component 5 and/or distribution channels of the distribution component 9 can also be utilized by performing signal leading out and/or signal branching at or in place of the bridge 12 between the respective channels. Additional signals can likewise be fed in or tapped off by the supply component 5 and/or by the functional components 10a to 10d.

In this case, the logic component 2 performs, in the sense of a selection or allocation of current paths, the function of a logic distributor which ensures a flexible signal distribution from and to the functional components 10a to 10d. It goes without saying that the logic component is configurable and can be equipped with bridges prior to incorporation or prior to mounting both intrinsically and as part of the installation system 1.

In addition to feeding the auxiliary voltage to the functional components 10a to 10d on the incoming side, provision is made for feeding in a further supply voltage, in particular main voltage, of a main circuit via a main current feed-in 13 of a connection device 14. On the outgoing side, by way of example, a load element or an electrical load 15 is connected to the functional component 10a via a further connection device 16. The electrical load 15 is embodied as a motor, in particular three-phase motor.

Both on the incoming side and on the outgoing side the functional component 10a has contact elements 17, by way of example, which are designed in such a way that mating contact elements 18 of the connection device 14 and further mating contact elements 19 of the further connection device 16 are compatible with one another. Accordingly, on the one hand, different, possibly modular connection devices can equally be contact-connected at both connection sides in each case, it being possible, on the other hand, to use different connection technologies.

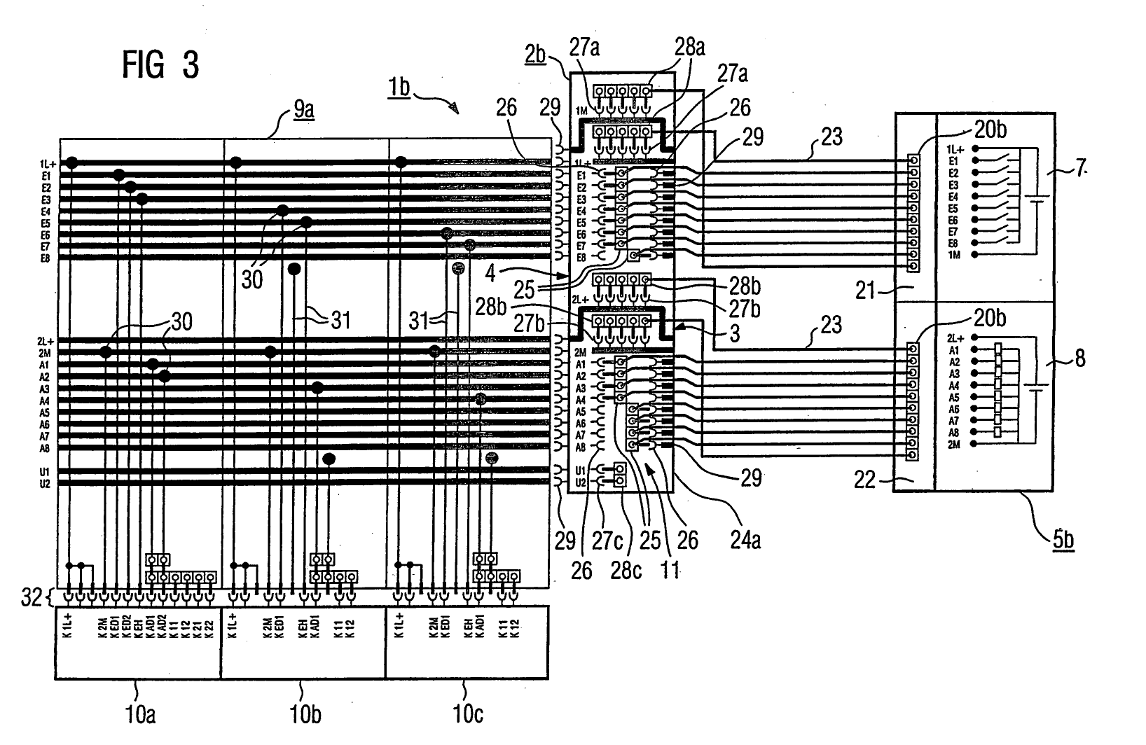

FIGS. 2 and 3 show different embodiments—having the logic component 2a and 2b—of the installation system 1a and 1b with the supply component 5a and 5b and the respective distribution component 9a. The supply component 5a and 5b on the one hand comprises an input component 7 provided with a series of the supply channels. The supply channels are in this case subdivided into eight input channels E1 to E8 and two current supply channels 1L+ and 1M.

On the other hand, the supply component 5a and 5b also has an output component 8, which is arranged beside the input component 7 and, for its part, is likewise equipped with a series of supply channels. These include eight output channels A1 to A8 and two further current supply channels 2L+ and 2M. The respective current supply channels are contact-connected via corresponding connection elements 20a, 20b.

In accordance with FIG. 2, there are arranged at the supply component 5a, in particular at the input component 7, a connection unit 21 and, in particular at the output component 8, a further connection unit 22 in the sense of a front plug-in module for making contact with the individual supply channels. The connection units 21 and 22 are electrically conductively connected via a common line 23, which, in accordance with the example embodiment, is prefabricated and has a bundle with two 2×16 cores, to a connection module 24a, in particular plug-in connection module, that is contact-connected to the logic component 2a, in the sense of an adapter for continuing the respective channels.

In addition to the prefabricated line 23, which can be embodied inter alia with bundled individual cores or as a ribbon lead or the like, the connection units 21, 22 and the connection module 24a are also embodied as a prefabricated unit together with the line 23. As an alternative to this, there is the possibility of wiring the connection module 24a with the connection units 21, 22 manually by use of individual cores. In this case, the connection units 21, 22 and the connection module 24a are provided with plug-in connections that permit convenient contact-connection. The 32 individual cores or phases are provided half each for the input component 7 and a corresponding first part of the logic distributor 2a and also for the output component 8 and a corresponding second part of the logic distributor 2a.

In accordance with FIG. 3, an embodiment variant is shown which makes it possible, in contrast to the embodiment variant according to FIG. 2, for the input and output components 7 and 8 with the connection units 21, 22 that can be plugged onto them to be electrically conductively connected directly. Thus, this may be done without the use of a connection module, to the logic component 2b via the line 23.

The connection units 21 and 22 are in each case provided with the connection elements 20b, in particular, embodied as multipole connection terminals. By way of the connection elements 20b, in accordance with the present example embodiment, 20 individual cores or phases, in the sense of the line 23, including the two current supply channels 1L+, 1M or 2L+, 2M, are individually contact-connected at one line side. At their other line side, the individual cores are connected to connection device(s) 25 arranged in the logic component 2b.

The logic component 2a and 2b in accordance with FIG. 2 and FIG. 3 or the respective appliance unit 11 is provided with contact locations 26 for making contact with the bridges 12 in accordance with FIG. 2 or for making contact with the connection device(s) 25 in accordance with FIG. 3. The contact-connection of the bridges 12 is provided between in each case two opposite contact locations 26. The connection device(s) 25, by contrast, are optionally connected to contact locations 26 which are electrically conductively connected to the supply component 5a, 5b in accordance with FIG. 2, 3 or to the respective distribution component 9a, so that a suitable interconnection can be performed depending on the intended use. In this case, signals can be fed in and/or tapped off at the corresponding supply component 5a, 5b or at the respective distribution component 9a.

In this case, the appliance unit 11 is embodied by way of the bridges 12 as an interface in the sense of signal interruption locations. In this case, by way of the bridges 12, connection channels corresponding to the supply channels can on the one hand be released or else enabled or interrupted. The connection channels are subdivided into eight input channels E1 to E8 and two current supply channels 1L+ and 1M, on the one hand, and also into eight output channels A1 to A8 and two further current supply channels 2L+ and 2M, on the other hand. The logic component 2a, 2b in accordance with FIG. 2, 3 is equipped with a plurality of contact location pairs 27a to 27c for making contact with further connection device(s) 28a to 28c via which different supply voltages can be fed in or tapped off.

In this case, a first and a second contact location pair 27a and 27b are available for a first and for a second supply voltage, respectively, and a third contact location pair 27c is available for a third supply voltage. It goes without saying that the magnitude of the supply voltages can be set in accordance with the given system requirements. The third supply voltage is passed to corresponding voltage supply channels U1 and U2. In accordance with the example embodiments as shown in FIG. 2 and FIG. 3, the connection device(s) 25 and the further connection devices 28a to 28c are advantageously designed in modular and detachable fashion, so that various or different connection technologies can be used.

The logic component 2a, 2b is intrinsically provided with a housing in the manner of a module, which has, at the first appliance location 3 and at the second appliance location 4, further contact locations 29 for making contact with at least one of the supply channels, on the one hand, and at least one of the distribution channels, on the other hand, for at least one of the connection channels. The contact locations 26, the contact location pairs 27a to 27c and the further contact locations 29 are embodied as plug contacts, it being possible, by way of example, to provide a contact variant as clamping contact or the like.

In addition to the electrical connection between the supply component 5a, 5b and the distribution component 9, the logic component 2a, 2b can also be arranged mechanically on one of the components. The distribution channels of the distribution component 9a are subdivided, in accordance with the supply and connection channels, into eight input channels E1 to E8 and two current supply channels 1L+and 1M, on the one hand, and also into eight output channels A1 to A8 and two further current supply channels 2L+ and 2M, on the other hand. It goes without saying that a multiple of the channel levels provided, for example a further eight, sixteen and/or thirty-two input and/or input channels, and possibly associated current supply channels, may be provided. The distribution component 9a in accordance with the two example embodiments according to FIG. 2 and FIG. 3 is embodied as an assembly having three regions with a predeterminable structural width oriented to the structural widths of functional components that can be connected in gridless fashion. The grouping e.g. of the switchgear on the distribution component 9a can accordingly be carried out as desired since the distribution channels are embodied continuously over the length of the functional assembly formed by the switchgear. Taps 30 are advantageously provided on the distribution channels, and electrically conductively connect the distribution channels to conductor tracks 31.

The conductor tracks 31, which can be embodied as rails, printed circuit board tracks, individual conductors or else ribbon conductors, lead to the functional components 10a to 10c individually or in a manner connected together via connecting locations 32 embodied as plug-in connections. The functional components 10a to 10c are in this case embodied as motor starter, the functional component 10a in particular as reversing starter and the functional components 10b, 10c in particular as direct starter. A motor starter has, in particular, a combination of a power circuit-breaker and a contactor. A reversing starter includes two directions of rotation, and a direct starter includes one direction of rotation.

At the functional components 10a to 10c—here embodied as switchgear—a series of contacts K1L+ and K2M, KED1 and KED2, KEH, K11 and K12, K21 and K22 and also KAD1 and KAD2 are provided in each case completely or partially, the corresponding conductor tracks 31 being connected to said contacts. The contact K1L+ is provided for feedback messages of auxiliary switches. The contact K2M serves as a common ground connection for driving the switchgear. A feedback signal of an auxiliary switch with regard to the switching state—first direction of rotation or second direction of rotation—of the respective switchgear appliance is respectively output via the contacts KED1 and KED2. Both contacts KED1 and KED2 are ultimately connected in each case via conductor tracks and channels to an input channel of the supply assembly 5a and 5b in accordance with FIG. 2 and FIG. 3.

The function of forwarding a feedback signal of the switching state of the power circuit-breaker—tripping or handling—to an input channel of the supply assembly 5 is provided by way of the contact KEH. The contacts K11, K12 and K21, K22 respectively serve for outputting a further feedback signal of a first and a second auxiliary break contact for the first direction of rotation and for the second direction of rotation, respectively. In accordance with FIG. 2 and FIG. 3, these contacts are not connected to a channel of the supply component 5a, 5b. An electrically conductive connection to contactor coils of the respective switchgear is in each case provided via the contacts KAD1 and KAD2, so that driving for the first direction of rotation or for the second direction of rotation can be effected via corresponding output channels of the supply component 5a, 5b.

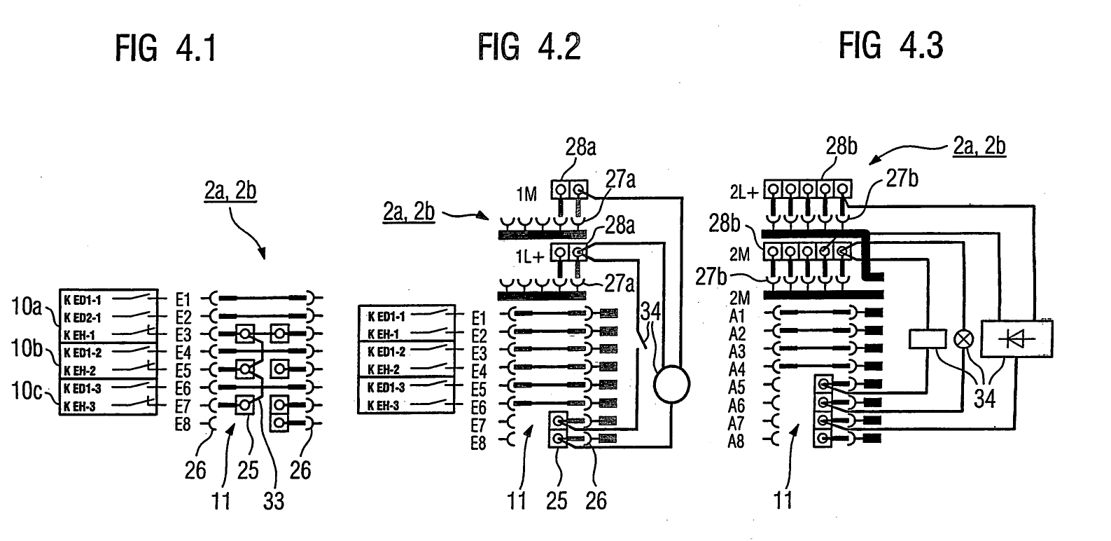

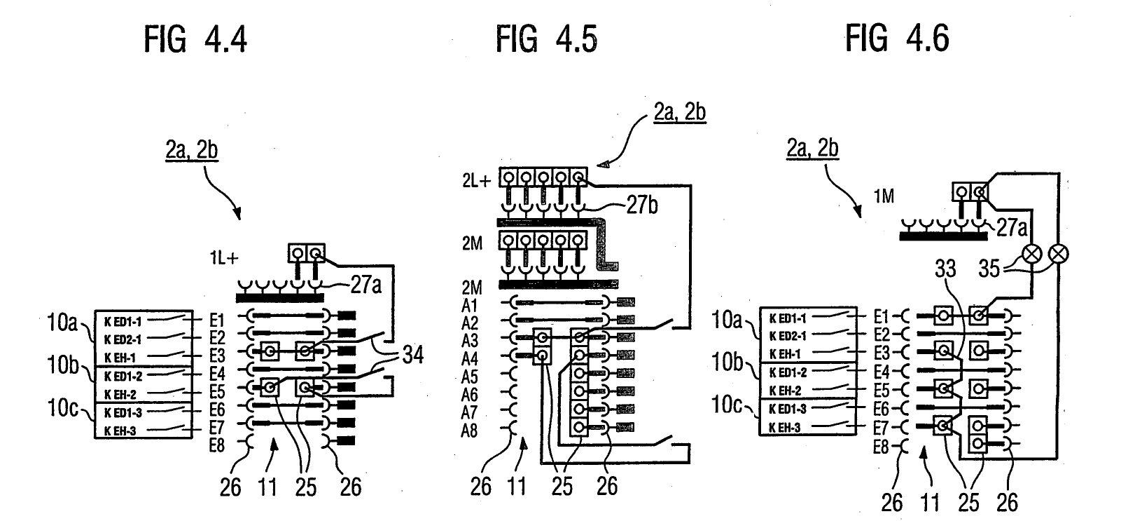

FIG. 4.1 to FIG. 4.6 show the installation appliance, in particular in each case a part of the logic component 2a, 2b and/or a part of the appliance unit 11 in accordance with FIGS. 2, 3, with different implementations. According to FIG. 4.1, the appliance unit 11 is provided with an electrically conductive connection 33 arranged between the contact locations 26 of the bridged input channel E3 and the functional-component-side contact locations 26 of the unbridged input channels E5 and E7 indirectly via the connection device(s) 25.

In this case, the input channels E3, E5 and E7 are electrically conductively connected, in a manner related to the functional component, to each of the contact KEH of the functional component 10a, to the contact KEH of the functional component 10b and to the contact KEH of the functional component 10c, respectively. The contacts KEH of the schematically illustrated functional components 10a to 10c are in each case embodied as auxiliary break contacts.

In this case, the possibility of at least one power circuit-breaker of the functional components 10a to 10c being in the OFF position is advantageously identified in the sense of a collective message or an aggregate signal. The input channels E5 and E7 which are unassigned as a result are available for the connection of external device(s).

In FIG. 4.2, two appliance-external functional elements 34 are provided, which are embodied as a sensor, in particular auxiliary switch or contactless proximity switch. In this case, the auxiliary switch is connected between one of the contact locations of the first contact location pair 27a indirectly via the associated further connection device(s) 28a and the supply-component-side contact location 26 of the unbridged input channel E7 indirectly via the connection device(s) 25.

The proximity switch has three outgoing connections, of which, for voltage supply purposes, the first and second outgoing connections are electrically conductively connected to the first contact location pair 27a indirectly via the associated further connection device(s) 28a. The third outgoing connection of the proximity switch is likewise connected indirectly, that is to say via the connection device(s) 25, to the supply-component-side contact location 26 of the unbridged input channel E8.

In the case of this embodiment variant, the input channels E7 and E8 in the logic component 2a on the part of the distribution component 9a e.g. in accordance with FIG. 2 are not assigned, so that the abovementioned functional elements 34 can advantageously be connected. The signals occurring in this case are read in via the input component 7 e.g. in accordance with FIG. 2 by the controller 6 in accordance with FIG. 1.

In FIG. 4.3, proceeding from the second contact location pair 27b, the associated further connection device(s) 28b and from the unbridged output channels A5 to A8, the functional elements 34, in particular actuators, are provided analogously to the sensors connected to the input channels E7 and E8 in accordance with FIG. 4.1. The actuators are designed in this case as contactor, soft starter, signaling luminaire and possibly as solenoid valve, by way of example. The contactor, in particular DC contactor, the signaling luminaire and also the solenoid valve are connected in accordance with the auxiliary switch as shown in FIG. 4.2 and the soft starter is connected in accordance with the proximity switch likewise as shown in FIG. 4.2.

In this case, too, the free output channels A5 to A8 are advantageously made usable by the connection of appliance-external actuators.

FIG. 4.4 and FIG. 4.5 respectively show the assignment of a bridged and an unbridged connection channel of the logic component 2a, 2b in accordance with FIGS. 2, 3. According to FIG. 4.4, one of the functional elements 34 embodied as an auxiliary switch is connected between one of the contact locations of the first contact location pair 27a and one of the contact locations 26 of the bridged input channel E3 indirectly in accordance with FIG. 4.2. The same applies to the auxiliary switch in accordance with FIG. 4.5, which is connected between one of the contact locations of the second contact location pair 27b and one of the contact locations 26 of the bridged output channel A3 indirectly in accordance with FIG. 4.3.

In the assignment of the unbridged input channel E5 in accordance with FIG. 4.4 and the unbridged output channel A5 in accordance with FIG. 4.5, the respective auxiliary switch is connected between the channel-identical contact locations 26 indirectly by the connection device(s) 25. Both embodiment variants can advantageously achieve a combination of signals from the functional components 10a to 10c or of control signals of the supply component 5a e.g. in accordance with FIG. 2 with external auxiliary switches. In this case, it is possible to provide logic AND, OR combinations.

FIG. 4.6 shows an appliance-internal and/or appliance-external indication device(s) 35 for each interconnection variant. In this case, one of the indication device(s) 35 is on the one hand connected between one of the contact locations of the first contact location pair 27a and one of the contact locations 26 of the bridged input channel E1. The respective other indication device(s) 35 is on the other hand connected between one of the contact locations of the first contact location pair 27a and the electrically conductive connection 33 that makes contact with identical-sided contact locations 26 of different unbridged input channels E3, E5 and E7. According to these example embodiments, too, the contact-connections are embodied indirectly via the corresponding connection device(s) 25.

The electrically conductive connection 33 is advantageously connected to the connection device(s) 25, which are embodied as modular connection terminals with a two-conductor connection. A general advantage of the present embodiment variant resides in the fact that it is possible to lead out signals from the functional components 10a to 10c via the distribution component 9a directly from the logic component 2a and 2b in accordance with FIG. 2 and FIG. 3. In this case, the signals, given the bridged input channel El, are forwarded to the respective supply component 5a, 5b and consequently also to the controller 6 in accordance with FIG. 1. This is not provided for the signals of the input channels E3, E5 and E7, so that the respectively opposite connection device(s) 25 and contact locations 26 are freely available. It goes without saying that the input channels can be interconnected in the sense of logic AND or OR combinations in accordance with FIGS. 4.4 and 4.5.

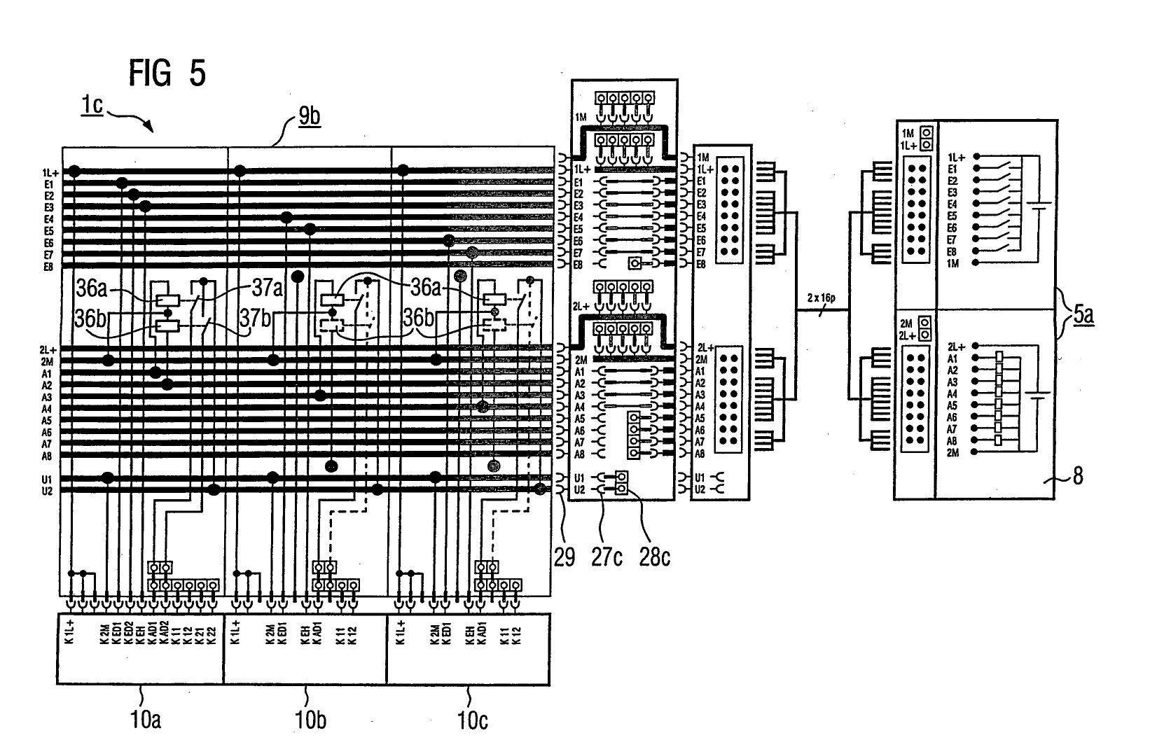

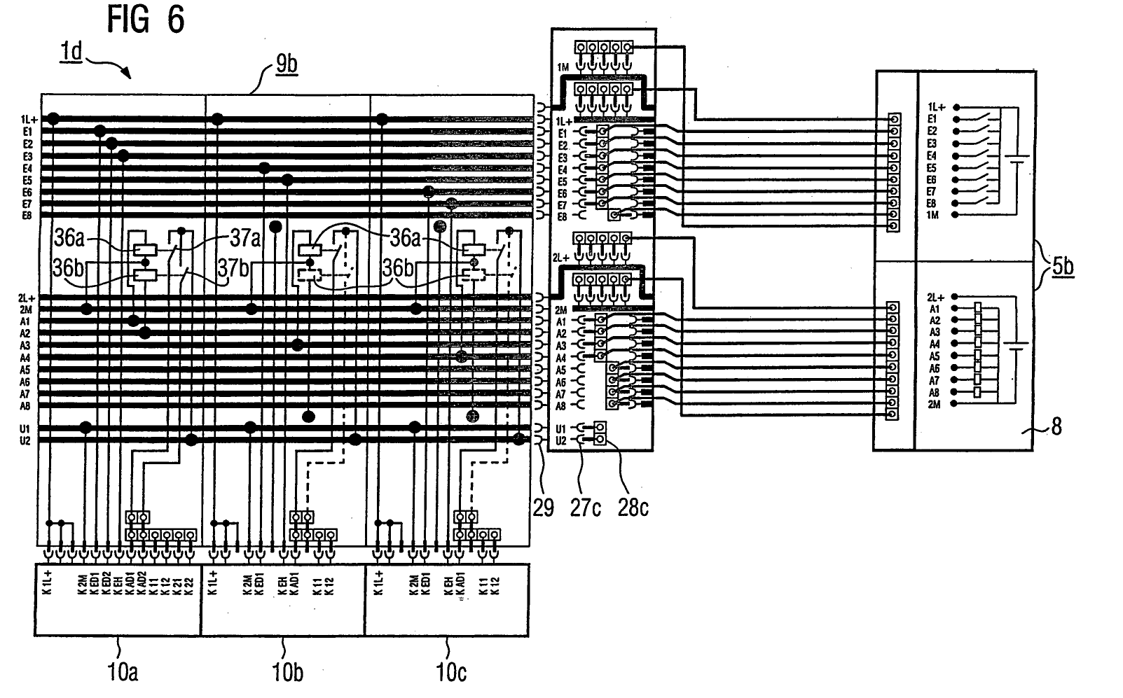

FIGS. 5 and 6 show different embodiments of the installation system 1c and 1d with implementations of the distribution component 9b and the supply component 5a, 5b in accordance with FIGS. 2, 3. The two embodiment variants of the installation system 1c and 1d differ in the embodiment of the channel wiring between the supply component 5a and 5b and the logic component 2a and 2b in accordance with the embodiments as shown in FIG. 2 and FIG. 3. The respective distribution component 9b of the two installation systems 1c and 1d has coupling components connected to the distribution channels in the region of the first functional component 10a, in particular a first and a second coupling relay 36a and 36b, for driving the switchgear. The coupling components may be used, depending on the system requirement, in the distribution component 9b for individual or a plurality of switchgear of a group in a targeted manner.

The two coupling relays 36a and 36b, which can also be embodied as electronic coupling components, actuate respectively associated switching contacts 37a and 37b independently of one another. In this case, the coils of the first and second coupling relays 36a and 36b are jointly connected to the current supply channel 2M, that is to say to ground, at one connection side. The first output channel A1 is connected at the other connection side of the first coupling relay 36a and the second output channel A2 is connected at the other connection side of the second coupling relay 36b. The two output channels are passed to the controller 6 in accordance with FIG. 1 by way of the logic component 2a, 2b and the output component 8 and are supplied with signals by said controller.

The switching contacts 37a and 37b are electrically conductively connected to the current supply channel U2 jointly in the sense of a current feeding connection. On the outgoing side, the switching contact 37a of the first coupling relay 36a is led to the contact KAD1 of the first functional component 10a. Analogously, the second switching contact 37b of the second coupling relay 36b is connected to the contact KAD2 of the first functional component 10a. In this case, the respective electric circuit of the first functional component 10a is closed by way of taps on the current supply channel U1, the third supply voltage being utilized. The third supply voltage is fed in to the associated third contact location pair 27c via the further connection device(s) 28c. Contact is made with the corresponding voltage supply channels U1 and U2 by way of the further contact locations 29 on the distribution component side.

The coupling relay 36a, arranged and connected in the region of the second and third functional components 10b and 10c, is embodied in accordance with the abovementioned purpose of use. Only the driving of the coupling relays 36a is effected via the third and fourth output channel A3 and A4, respectively. The respective second coupling relay 36 can be provided optionally, that is to say depending on the equipment of the functional component, in both associated regions. If a start signal is output by the controller 6 in accordance with FIG. 1 for the purpose of switching, the coil of the respective coupling component is driven.

The coupling component consequently switches in the supply voltage via the drive power of the output component 8, so that the contact KAD1—also called start input—of a motor starter is acted upon. The associated contactor is excited and switches in the main voltage for starting one of the electric motors e.g. in accordance with FIG. 1. It goes without saying that the interconnection variants with the corresponding signal feedback messages about the respective switching states in accordance with FIGS. 4.1 to 4.6 can also be used in the embodiments in accordance with FIGS. 5, 6.

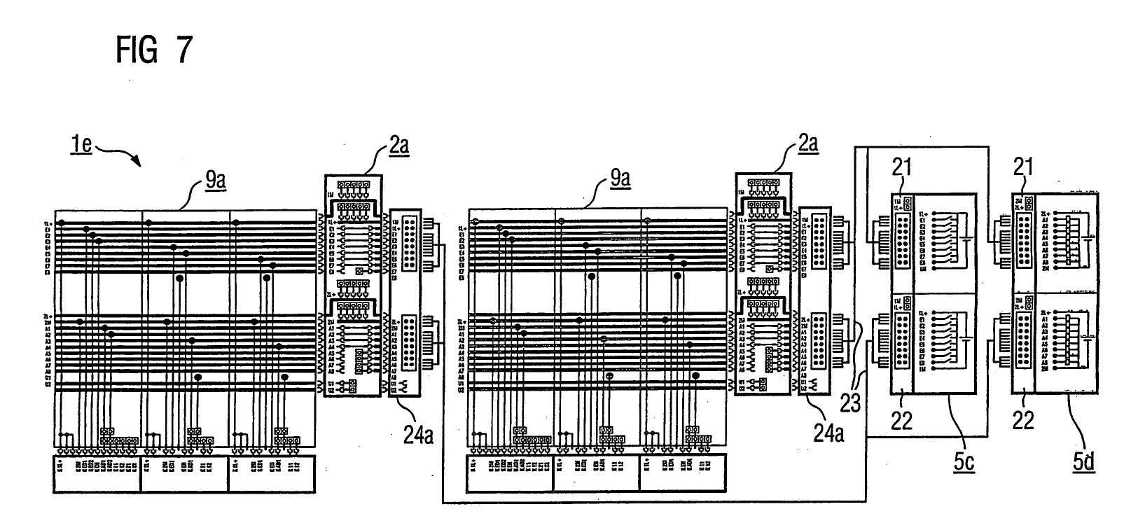

FIGS. 7 to 10 show advantageous configurations of the installation system 1e to 1h which have different embodiments of the logic component 2a and 2c to 2f, of the supply component 5a, 5c and 5d and also of the distribution component 9a. FIG. 7 shows an advantageous embodiment variant of the installation system le, two structurally identical distribution components 9a, which, however, are embodied separately and in constructionally separated fashion, being connected to a respective structurally identical logic component 2a in the sense of a first and a second functional group. The connection channels of one logic component 2a are led to the two connection units 22 of the supply component 5c and 5d by way of the connection module 24a and the prefabricated line 23.

Furthermore, the connection channels of the other logic component 2a are electrically conductively connected to the two connection units 21 of the supply component 5c and 5d by way of the associated connection module 24a and the corresponding prefabricated line 23. The connection units 21, 22 plugged onto the corresponding supply components 5c, 5d are intended for two times eight input channels with regard to the first functional group and for two times eight output channels with regard to the second functional group. In this case, the topology of the two functional groups in each case corresponds to the basic construction of the installation system la in accordance with FIG. 2, driving being provided by way of the common controller 6 in accordance with FIG. 1.

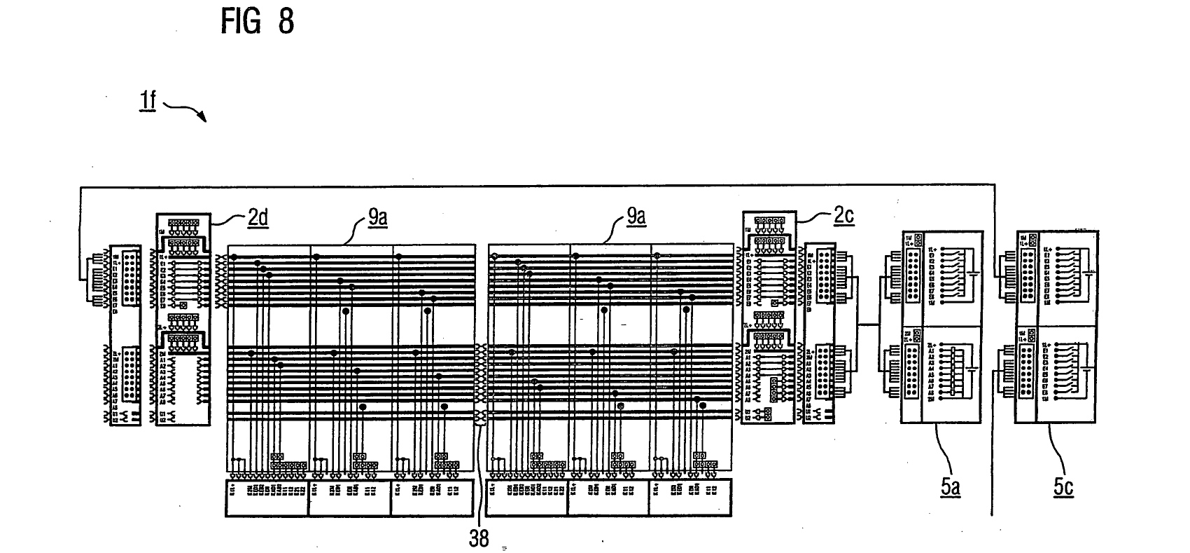

FIG. 8 shows an advantageous configuration of the installation system 1f, which has two structurally identical and moreover constructionally connected distribution components 9a. The two distribution components 9a are electrically conductively coupled by way of a plug connection 38 at corresponding distribution channels with regard to their output channels A1 to A8, associated current supply channels 2L+ and 2M and also the voltage supply channels U1, U2. The lengthening of the current paths afforded in this case makes it possible to connect four direct starters and two reversing starters which require in total fourteen input channels and eight output channels for driving and feedback. In an advantageous manner, beside the eight output channels the input channels apart from the two input channels E8 are also assigned. At the distribution component 9a and the further distribution component 9a, one of the logic components 2c and 2d is in each case provided in the sense of the first and the second functional group in accordance with FIG. 7, so that the two input channels E8 can also be utilized.

The two logic components 2c and 2d in principle have the construction of the logic component 2a e.g. in accordance with FIG. 2. In one case, however, all connection channels are unbridged since no connection to the distribution channels of the associated distribution component 9a is provided. In the other case, all output channels A1 to A8 are embodied in bridged fashion. The electrically conductive connection between the logic component 2c and the supply component 5a is embodied e.g. in accordance with FIG. 2. The same applies to the driving of the logic component 2d, which is connected to the supply component 5c, only eight input channels being required. The further eight input channels of the supply component 5c are available for free utilization in the same way as the respective input channel E8 of the logic components 2a e.g. in accordance with FIG. 7 and also 2c and 2d e.g. in accordance with FIG. 8, so that this construction and the resultant looping through of the signals advantageously reduces the number of free input and output channels compared with a construction having two separate functional groups.

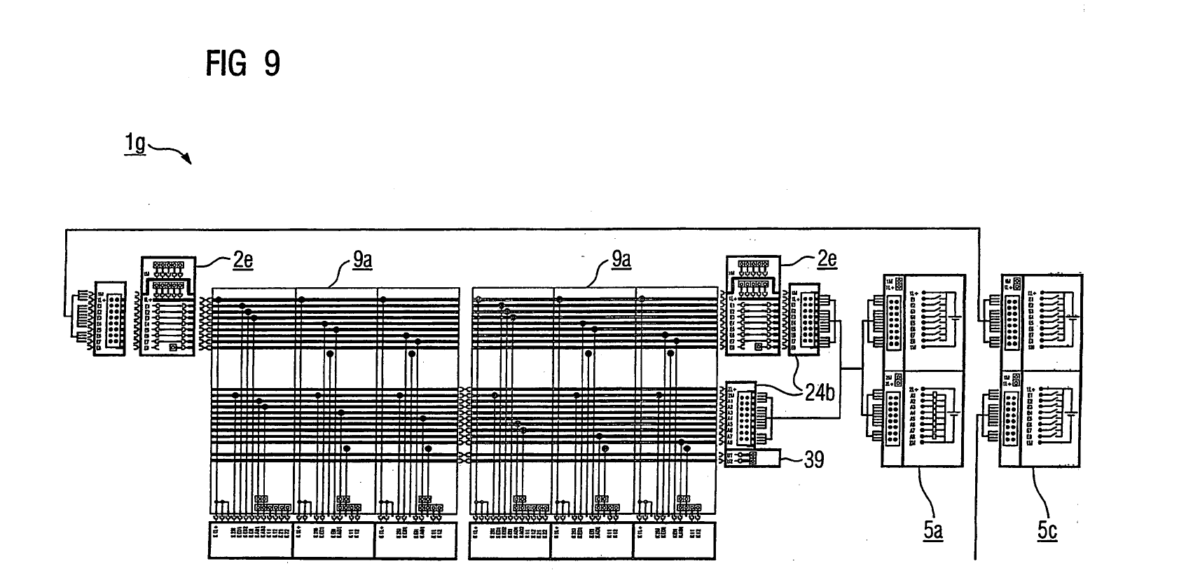

FIG. 9 shows an advantageous embodiment variant of the installation system 1g, which differs from the embodiment variant in accordance with FIG. 8 by the fact that logic components 2e reduced in terms of their number of channels are used instead of the two logic components 2c and 2d according to FIG. 8. In this case, the logic components 2e are connected to the respective input channels E1 to E8 and to one of the current supply channels 1L+ of the distribution components 9a. The electrically conductive connection between the logic component 2e and the supply component 5a is embodied in principle e.g. in accordance with FIG. 2, but a connection module 24b divided into two parts is used. The first part is connected to the logic component 2e and the second part is directly connected to the distribution component 9a.

The contact-connection of the voltage supply channels U1 and U2 can possibly be obtained by way of a separate module 39. The connection of the logic component 2e to the supply component 5c is embodied e.g. in accordance with FIG. 8. The further eight input channels of the supply component 5c are advantageously available for free assignment in the same way as the respective input channel E8 of the logic components 2e. As a result of the subdivision, the modules turn out to be small and cost-effective and can be used as needed, so that no overcapacities arise.

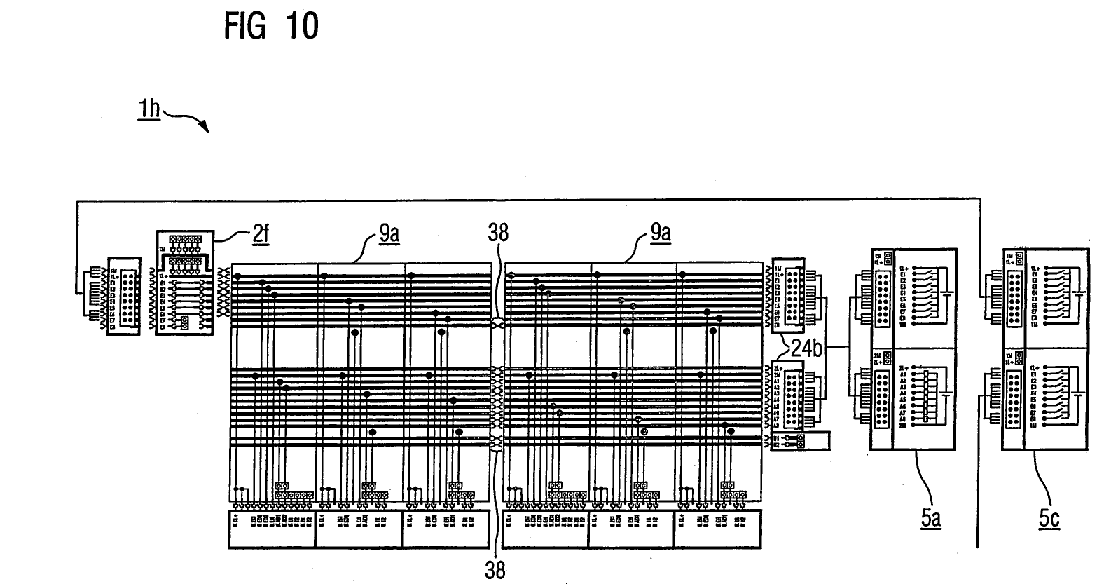

FIG. 10 shows a further advantageous configuration of the installation system 1h, which is based on the embodiment variant in accordance with FIG. 9. A first difference is that the connection module 24b divided into two parts is directly connected to the distribution channels of the distribution component 9a both at the input channel level and at the output channel level, so that one logic component 2e in accordance with FIG. 9 can be obviated.

The two distribution components 9a furthermore have for the input channel E8, inter alia, the plug connection 38 by way of which individual or a plurality of input and/or output channels of the distribution components 9a can be lengthened. A further difference is given by the fact that instead of the logic component 2e in accordance with FIG. 9, in the present example embodiment the logic component 2f is connected, in the case of which the input channels E7 and E8 are provided for contact-connection of external device(s). It goes without saying that the interconnection variants in accordance with FIGS. 4.1 to 4.6 and the designs of the distribution components in accordance with FIGS. 5, 6 can also be used in the embodiments in accordance with FIGS. 7 to 10.

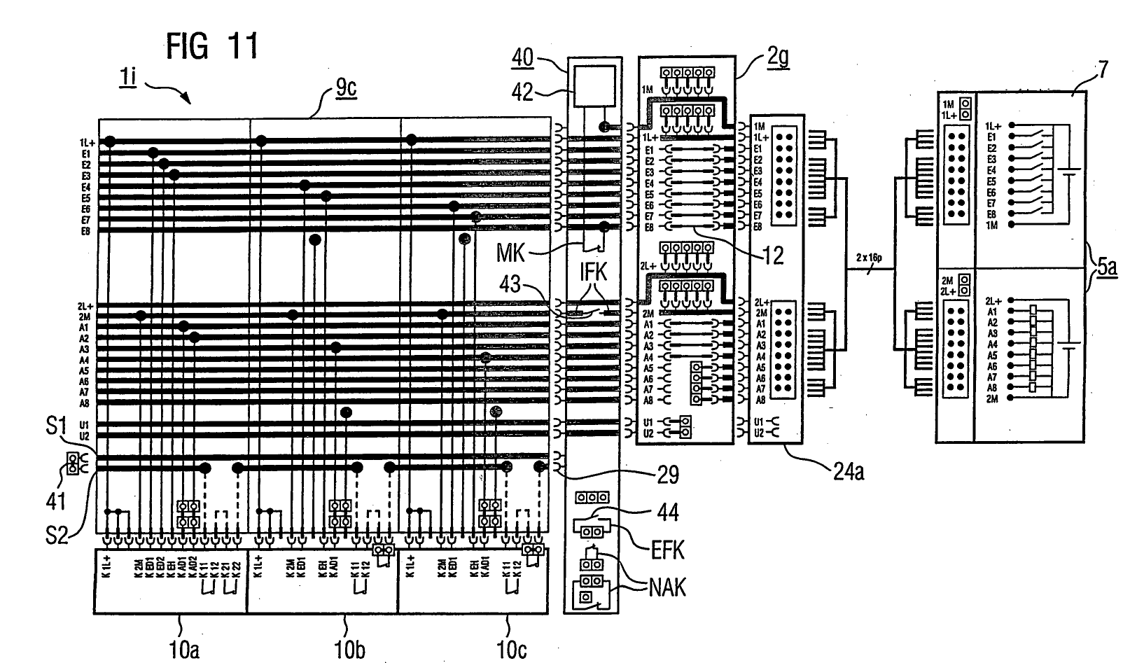

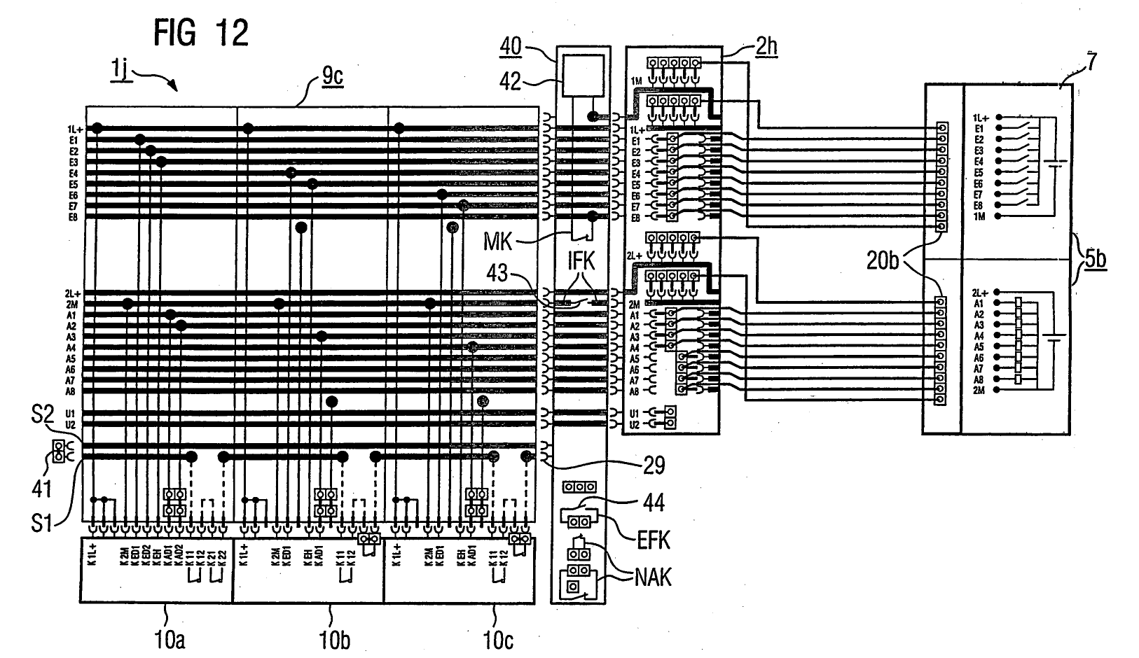

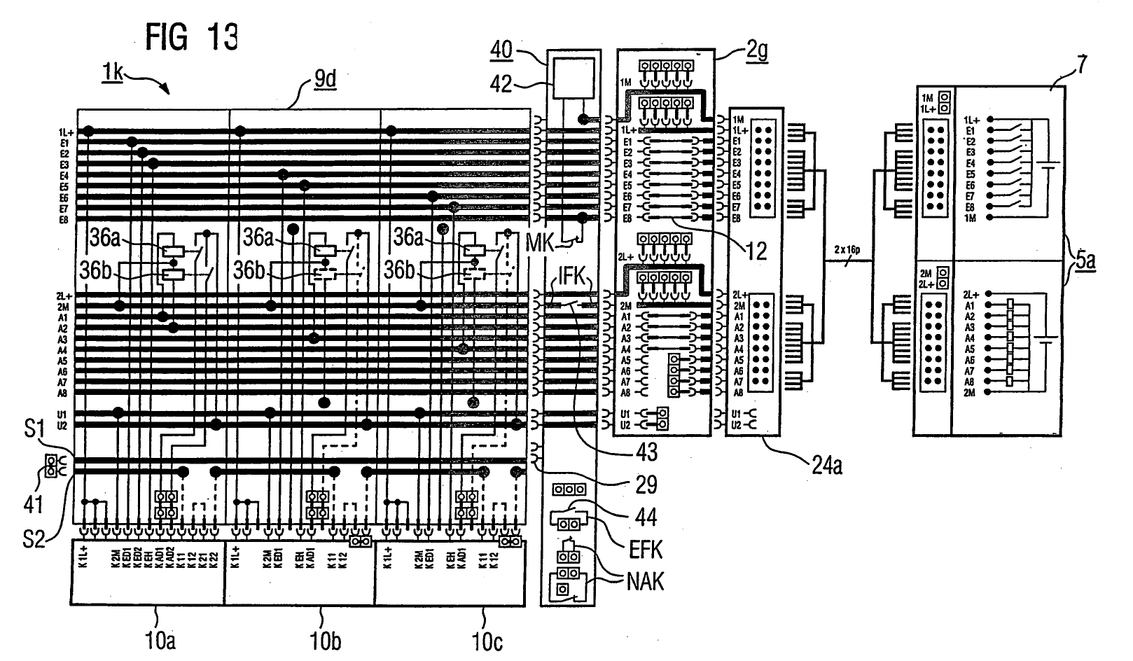

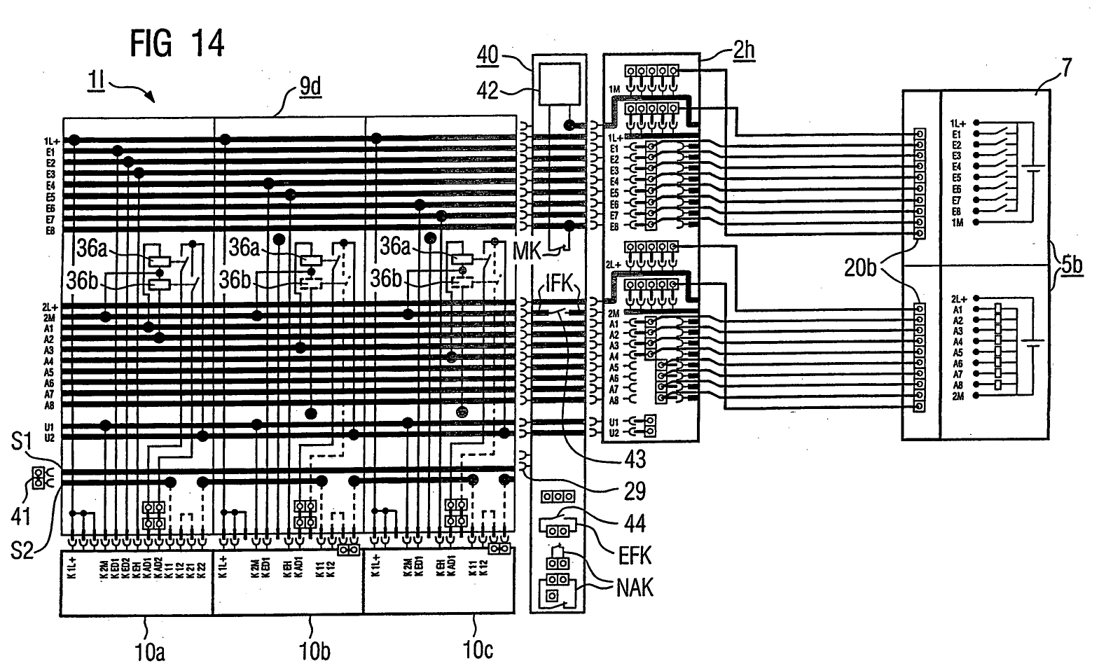

FIGS. 11 to 14 show advantageous configurations of the installation system 1i to 11 which in each case have a third device, in particular evaluation component 40. The evaluation component 40 is connected with a predeterminable number of evaluation channels between the distribution component 9c, 9d and the logic component 2g, 2h via a plug interface. The logic component 2g in accordance with FIG. 11 and FIG. 13 is embodied e.g. in accordance with the logic component 2a in accordance with FIG. 2, the eighth input channel E8 also being provided with a bridge 12. The same applies analogously to the logic component 2h in accordance with FIG. 12 and FIG. 14, which is based e.g. on the logic component 2b in accordance with FIG. 3.

Accordingly, in the case of FIGS. 11 and 13, an indirect wiring by way of the connection module 24a in the sense of an adapter for continuing the respective channels is afforded for example in accordance with FIG. 2. Furthermore, the embodiments in accordance with FIG. 12 and FIG. 14 provide a direct connection by the connection elements 20b e.g. in accordance with FIG. 3.

The advantageous implementations of the distribution components 9c and 9d in accordance with FIGS. 11 and 12 and, respectively, 13 and 14 in each case have a safety circuit with safety channels S1, S2 and, at the component end, in each case a circuit bridge 41, in particular terminal. The circuit bridge 41 serves on the one hand as a connecting piece and on the other hand as a spacer for external switchgear to be linked in. The safety channel S2 is looped via the contacts K11, K12 and possibly K21 and K22 of the respective auxiliary break contacts of the functional components 10a to 10c. At the functional components 10b and 10c forming the functional group, external auxiliary switches can additionally be integrated into the safety circuit—also called feedback circuit. The safety channels S1 and S2 are finally led to contact locations 29 of the evaluation component 40, which monitors the functional components 10a to 10c, in particular switchgear, for operational reliability by way of an evaluation unit 42.

Operational reliability includes, inter alia, the switching function of a contactor of the functional components 10a to 10c. The auxiliary break contact integrated in the contactor is designed as a positively driven contact, the switching state thereof being interrogated by the evaluation component 40. If voltage is not applied to the functional components 10a to 10c, in particular the respective contactors, and the auxiliary break contacts are accordingly closed in a constrained manner, the evaluation component 40 enables the functional group for switch-on by way of an internal enabling circuit IFK.

In addition to the internal enabling circuit IFK having an auxiliary make contact 43 for enabling the respective contactors, an internal enabling circuit EFK is provided, in particular in floating fashion, as part of the evaluation component 40. The external enabling circuit EFK serves, by way of a further auxiliary make contact 44, for enabling further switchgear that can be arranged externally. Both the internal and external enabling circuit IFK and EFK, respectively, are acted upon synchronously by the evaluation unit 42—embodied as an electronic module here. In addition to the safety circuit, a two-channel EMERGENCY OFF circuit NAK is provided for the evaluation component 40.

If an EMERGENCY OFF command is generated via one of the two EMERGENCY OFF channels, for example by way of an EMERGENCY OFF switch, this state is detected by the evaluation unit 42. The evaluation unit 42 acts on the auxiliary make contact 43 and on the further auxiliary make contact 44 of the internal and external enabling circuits IFK and EFK, so that the latter are opened. The auxiliary make contact 43 of the internal enabling circuit IFK is advantageously linked into one of the evaluation channels—here the ground channel—which serves for leading through the current supply channel 2M. The functional components 10a to 10c that are fed by the current supply channel 2M, inter alia, are accordingly switched inactive by the interruption of the electric circuit. The evaluation unit 42 detects the state change in the safety circuit and, by way of an internal signaling circuit MK, outputs an alerting signal via an evaluation channel—corresponding to the input channel E8—to the supply component 5a, 5b, in particular to the input component 7 thereof.

In FIGS. 13 and 14, the respective distribution components 9d, in an advantageous configuration, likewise have the coupling relays 36a, 36b e.g. in accordance with FIGS. 5 and 6. It goes without saying that the interconnection variants in accordance with FIGS. 4.1 to 4.6 can also be used in the embodiments in accordance with FIGS. 13, 14.

The embodiments of the invention explained above may be summarized as follows:

In order to specify an installation appliance and an installation system 1, 1a-1l comprising at least one installation appliance 2, 2a-2h which respectively ensure an efficient wiring with simple device(s) for connectable devices having a given number of current paths, it is provided that the installation appliance 2, 2a-2h can be contact-connected, at different-sided connection channels, to a device 5, 5a-5d, a further device 9, 9a-9d or a third device 40 each having a predeterminable number of current paths, in which case the current flow in at least one of the current paths 1L+, 1M, E1-E8 or 2L+, 2M, A1-A8 can be influenced by way of an appliance unit 11.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. An installation appliance, comprising:
a predeterminable number of current paths, contact connectable both at a first appliance location and at a second appliance location provided for a current flow;
a device, at one of the appliance locations having a predeterminable number of current paths, connectable to the connection channels;
a further device, at the respective other appliance location having a respectively predeterminable number of current paths and connectable to the connection channels; and
an appliance unit, to influence the current flow in at least one of the current paths.

2. The installation appliance as claimed in claim 1, wherein
the appliance unit is configured as an interface in such a way that at least one of the connection channels is at least one of leadable through and, interruptable via an electrically conductive bridge.

3. The installation appliance as claimed in claim 1, further comprising
contact locations for making contact with at least one connection device for at least one of the connection channels.

4. The installation appliance as claimed in claim 3, further comprising
an electrically conductive connection between a contact location of a bridged connection channel and at least one contact location of an unbridged connection channel.

5. The installation appliance as claimed in claim 1,
further comprising further contact locations for making contact with one of the supply channels on the one hand, and one of the distribution channels on the other hand, for at least one of the connection channels.

6. The installation appliance as claimed in claim 1, further comprising at least one contact location pair for making contact with at least one further connection device via which different supply voltages can be at least one of fed in and can be tapped off.

7. The installation appliance as claimed in claim 3, further comprising
a modular, detachable design of the at least one connection device.

8. The installation appliance as claimed in claims 3, wherein
a design of the contact locations of the contact location pair is at least one of a plug and clamping contacts.

9. The installation appliance as claimed in claim 3, further comprising
a functional element, connectable between at least one of the contact locations of the contact location pair and one of the contact locations of an unbridged connection channel.

10. The installation appliance as claimed in claim 9, further comprising
a connection of the functional element between contact locations of an unbridged connection channel.

11. The installation appliance as claimed in claim 3, further comprising
a connection of the functional element between one of the contact locations of the contact location pair and one of the contact locations of a bridged connection channel.

12. The installation appliance as claimed in claim 3, further comprising at least one indication device, connectable between one of the contact locations of the contact location pair and an electrically conductive connection that makes contact with identical-sided contact locations of different unbridged connection channels.

13. The installation appliance as claimed in claim 12,
further comprising a connection of the at least one indication device between one of the contact locations of the contact location pair and one of the contact locations of a bridged connection channel.

14. An installation system, comprising:
at least one installation appliance, including a predeterminable number of current paths, which are contact connectable both at a first appliance location and at a second appliance location and provided for a current flow;
a device, connectable to the connection channels at one of the appliance locations and including a predeterminable number of current paths;
a further device, connectable to the connection channels at the respective other appliance location and including a predeterminable number of current paths; and
an appliance unit, to influence the current flow in at least one of the current paths.

15. The installation system as claimed in claim 14, further comprising
a third device, connectable between the installation appliance with connection channels and the further device with distribution channels and including a predeterminable number of evaluation channels.

16. The installation system as claimed in claim 14, wherein
the appliance unit is configured as an interface in such a way that at least one of the connection channels can be at least one of lead through, interrupted, via an electrically conductive bridge.

17. The installation system as claimed in claim 14, further comprising
contact locations for making contact with at least one connection device for at least one of the connection channels.

18. The installation system as claimed in claim 17, further comprising an electrically conductive connection between a contact location of a bridged connection channel and at least one contact location of an unbridged connection channel.

19. The installation system as claimed in claim 14, further comprising
further contact locations for making contact with one of the supply channels on the one hand, and one of the distribution channels on the other hand, for at least one of the connection channels.

20. The installation system as claimed in claim 14, further comprising
at least one contact location pair for making contact with at least one further connection device via which different supply voltages can be at least one of fed in and tapped off.

21. The installation system as claimed in claim 17,
having a modular, detachable design of the at least one connection device.

22. The installation system as claimed in claim 19,
having a design of the contact locations as at least one of plug and clamping contacts.

23. The installation system as claimed in claim 16,
further comprising a functional element, connectable between at least one of the contact locations of the contact location pair and one of the contact locations of an unbridged connection channel.

24. The installation system as claimed in claim 23, further comprising
a connection of the functional element between contact locations of an unbridged connection channel.

25. The installation system as claimed in claim 23, further comprising
a connection of the functional element between one of the contact locations of the contact location pair and one of the contact locations of a bridged connection channel.

26. The installation system as claimed in claim 17, further comprising
at least one indication device connectable between one of the contact locations of the contact location pair and an electrically conductive connection that makes contact with identical-sided contact locations of different unbridged connection channels.

27. The installation system as claimed in claim 27,
comprising a connection of the at least one indication device between one of the contact locations of the contact location pair and one of the contact locations of a bridged connection channel.

28. The installation system as claimed in claim 14, further comprising
a connection unit arranged at the supply component, which connection unit is electrically conductively connected via a line to a connection module, arranged at least one of at the logic component, at the distribution component and at the evaluation component, in the sense of an adapter for continuing the respective channels.

29. The installation system as claimed in claim 28 wherein
a design of the connection unit includes connection elements that are electrically conductively connected via the line directly to the at least one connection device of at least one of the logic component, the distribution component and the evaluation component.

30. The installation system as claimed in claim 29,
having a prefabricated configuration of at least one of the line, the connection unit and the connection module.

31. The installation system as claimed in claim 14, further comprising at least one coupling relay, assignable to the distribution component and connectable to the distribution channels thereof and provided for applying one of the supply voltages to at least one functional component.

32. The installation system as claimed in claim 31,
having a grid-free arrangement of at least one of the functional components at the distribution channels.

33. The installation system as claimed in claim 31,
having at least one further distribution component, coupleable to the distribution component.

34. The installation system as claimed in claim 31,
further comprising at least one of an emergency off circuit and safety circuit for one or more switches which is integrated in the distribution component.

35. The installation system as claimed in 34, further comprising
an evaluation unit integrated in the evaluation component, which evaluation unit, in a manner dependent on the at least one of emergency off circuit and safety circuit, influences at least one of a signaling circuit, an internal enabling circuit and an external enabling circuit.
